(19) United States
(12) Patent Application Publication
(10) Pub. No.: US 2004/0192150 A1
(43) Pub. Date: Sep. 30, 2004

(54) Method of manufacturing color selection electrode structure for color cathode ray tube

(76) Inventors: Keizou Makino, Tokyo (JP); Takeshi Tsukasaki, Tokyo (JP)

Correspondence Address: BIRCH STEWART KOLASCH & BIRCH, PO BOX 747, FALLS CHURCH, VA, 22040-0747, US

(21) Appl. No.: 10/699,773

(22) Filed: Nov. 4, 2003

(30) Foreign Application Priority Data
Mar. 26, 2003 (JP) 2003-084480

(51) Int. Cl. H01J 9/12

(52) U.S. Cl. 445/47

(57) ABSTRACT

H-members (11) each have an approximately triangular shape in cross section, and are controlled to be small in thickness especially for weight reduction. A position for applying a pressure by a pressure member (23) is determined in such a way that a contact surface (27) of the pressure member (23), which comes into contact with the H-members (11), covers a joint (S1) between two sides of each of the H-members (11) having an approximately triangular shape in cross section. The pressure member (23) applies a pressure through surface-to-surface contact, and thereafter, grille strips (12) are cooperatively fixed to the H-members (11). As a result, a tension distribution causing no degradation of a display oscillation property is obtained. Further, application of a pressure by the pressure member (23) causes no partial deformation of the H-members (11), whereby generation of a wrinkle is prevented.

### BACKGROUND OF THE INVENTION

1. Field of the Invention

The present invention relates to a method of manufacturing a color selection electrode structure for a tension mask color cathode ray tube, which manufacturing method is more particularly directed to a color selection electrode structure for a stable tension mask color cathode ray tube capable of providing a tension distribution that causes no degradation in display oscillation property.

2. Description of the Related Art

Well-known color selection electrode structures for a color cathode ray tube include a non-tension mask (which is a so-called shadow mask) technique and a tension mask technique.

In the tension mask technique, each grille strip constituting a mask is placed under tension for absorbing expansion of the mask, which absorption is caused by rise in temperature in the mask as a result of collision of electron beams, for example. That is, a so-called “tension mask” is realized.

More particularly, while support members arranged in parallel are under pressure to get closer to each other, grille strips constituting a mask are cooperatively fixed by seam welding between these support members. This allows a tension to be caused in each of the grille strips of the mask by the resilience of the support members when the pressure 1to the support members is released at a later stage. An exemplary technique of which is introduced in Japanese Patent Application Laid-Open No. 9-007508 (1997).

In such a tension mask technique, with the intention to avoid vibration, a pair of damper wires are laid across in a tensioned state to be perpendicular to each of the grille strips.

In order to avoid display oscillation caused by an impact from outside, the tension mask technique requires that a tension to be applied to all the grille strips should be at a predetermined level or more, and that such a tension should have a distribution with a smooth curve.

Otherwise, a grille strip under low tension adjacent to a grille strip under high tension is likely to vibrate in response to display oscillation.

As described, in the tension mask technique, support members arranged in parallel are under pressure to get closer to each other when grille strips are fixed therebetween by seam welding. The applied pressure creates an indentation in the support members, thus partially causing deformation thereof.

Such partial deformation prevents smooth warpage of the support members on the whole, causing displacement of a part of the grille strips and thus non-uniformity in contact between damper wires and a mask. Such non-uniformity causes the damper wires to break off contact with a part of the grille strips, thereby spoiling effective functionality of the damper wires. As a result, instability of an image is generated by display oscillation, leading to degradation in display quality of the image.

### SUMMARY OF THE INVENTION

In the tension mask technique, it is therefore an object of the present invention to provide a method of manufacturing a color selection electrode structure for a color cathode ray tube providing a tension distribution in a mask that causes no degradation in display oscillation property. In this method, it is another object of the present invention to avoid generation of partial deformation of the mask when it is stretched and thereby prevent generation of a wrinkle in the mask, to obtain stability in image quality.

In a method of manufacturing a color selection electrode structure for a color cathode ray tube of the present invention, the color selection electrode structure includes a pair of support members opposite to each other, elastic members, and a plurality of grille strips. The elastic members support the support members, while applying a bias to the support members in such a manner that the support members go farther from each other. The plurality of grille strips each have two ends supported by the support members. The method comprises the following steps a) through d). In the step a), a pressure is applied by a pressure member to the support members to be closer to each other. In the step b), while the pressure applied in the step a) is maintained, the plurality of grille strips are cooperatively fixed between the support members. In the step c), the pressure applied to the support members is released, to cause a tension in each of the plurality of grille strips supported by the support members using resilience of the elastic members. In the step d), a damper wire is placed to be in contact with each of the plurality of grille strips. The support members are each a thin plate approximately triangular in cross section. In the step a), a contact surface of the pressure member which comes into contact with the support members covers a joint between two sides of each of the support members having an approximately triangular shape in cross section.

The contact surface of the pressure member which comes into contact with the support members covers a joint between two sides of each of the support members having an approximately triangular shape in cross section. With the support members each having an approximately triangular shape in cross section which are controlled to be small in thickness especially for weight reduction, a tension distribution causing no degradation of a display oscillation property is thereby obtained. Further, application of a pressure by the pressure member causes no partial deformation of the support members, whereby generation of a wrinkle is prevented.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view illustrating an exemplary color selection electrode structure;

FIG. 2 is a front view illustrating a position for applying a pressure in a step of manufacturing the exemplary color selection electrode structure;

FIG. 3 is a partially enlarged front view illustrating application of a pressure in a step of manufacturing the exemplary color selection electrode structure;

FIG. 4 is a partially enlarged perspective view of a pressure cylinder for applying a pressure in a step of manufacturing the exemplary color selection electrode structure;

FIG. 5 is a partially enlarged perspective view illustrating an indentation caused in an H-member in a step of manufacturing the exemplary color selection electrode structure;

FIG. 6 is a perspective view illustrating a color selection electrode structure for a color cathode ray tube according to a preferred embodiment of the present invention;

FIG. 7 is a perspective view illustrating a frame with no grille strips of the color selection electrode structure for a color cathode ray tube according to the preferred embodiment of the present invention;

FIGS. 8 and 9 are a perspective view and a sectional view, respectively, each illustrating a pressure member used in a method of manufacturing the color selection electrode structure for a color cathode ray tube according to the preferred embodiment of the present invention;

FIG. 10 is a sectional view illustrating how the pressure member is assembled which is used in the method of manufacturing the color selection electrode structure for a color cathode ray tube according to the preferred embodiment of the present invention;

FIG. 11 is a schematic view illustrating an example of the method of manufacturing the color selection electrode structure for a color cathode ray tube according to the preferred embodiment of the present invention;

FIG. 12 is a graph showing a tension distribution in grille strips which are placed in a tensioned state after the method of FIG. 11 has been performed;

FIG. 13 is a schematic view illustrating another example of the method of manufacturing the color selection electrode structure for a color cathode ray tube according to the preferred embodiment of the present invention;

FIG. 14 is a graph showing a tension distribution in grille strips which are placed in a tensioned state after the method of FIG. 13 has been performed;

FIG. 15 illustrates a contact surface of a pressure element at an improper position;

FIG. 16 is a graph showing a tension distribution in grille strips which are placed in a tensioned state after the method of FIG. 15 has been performed;

FIG. 17 is a perspective view illustrating a wrinkle generated in an outer wall of an H-member by the use of the pressure cylinder in manufacturing the exemplary color selection electrode structure; and

FIG. 18 is a graph showing a tension distribution in grille strips which are placed in a tensioned state after generation of a wrinkle in the outer wall of the H-member.

### DESCRIPTION OF THE PREFERRED EMBODIMENTS

Exemplary Color Selection Electrode Structure

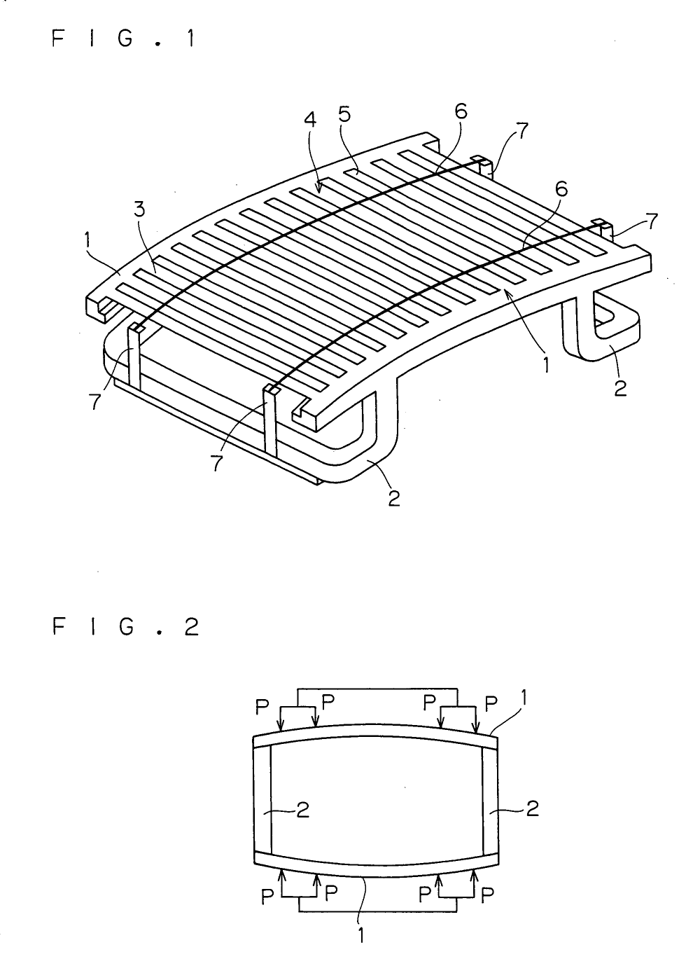

Prior to the discussion of a color selection electrode structure for a color cathode ray tube according to a preferred embodiment of the present invention, an exemplary color selection electrode structure for a cathode ray tube, which is conventionally used and is not applied to the present invention, will be described for the sake of convenience. FIG. 1 is a perspective view illustrating an example of a conventional color selection electrode structure for a color cathode ray tube using a tension mask technique.

The color selection electrode structure of FIG. 1 comprises laterally-extending H-members (support members) 1 as top and bottom legs of a frame, and V-members (elastic base members) 2 as side legs of the frame each having a longer part in a vertical direction.

A plurality of vertically-extending grille strips 3 are provided to be in parallel with each other between the H-members 1 to form an aperture grille 4. Openings defined between adjacent ones of the grille strips 3 are operative to serve as slits 5 for allowing light to pass through.

In contrast to a color selection electrode structure of the preferred embodiment of the present invention, the H-members 1 and the V-members 2 of this conventional color selection electrode structure are relatively large in thickness. By way of example, the H-members 1 may be L-shaped in cross section, with a thickness in the range of about 4 to 6 mm. The V-members 2 may be angular solids, with a thickness in the range of about 9 to 20 mm.

The color selection electrode structure of FIG. 1 is provided with a pair of damper wires 6 contacting all the grille strips 3 to prevent vibration thereof. The damper wires 6 are each perpendicular to the grille strips 3. To maintain tension of the damper wires 6, both ends of each damper wire 6 are supported by tips of elastic damper springs 7 provided outside of each damper wire 6. The damper springs 7 each have a base end fixed to the V-member 2.

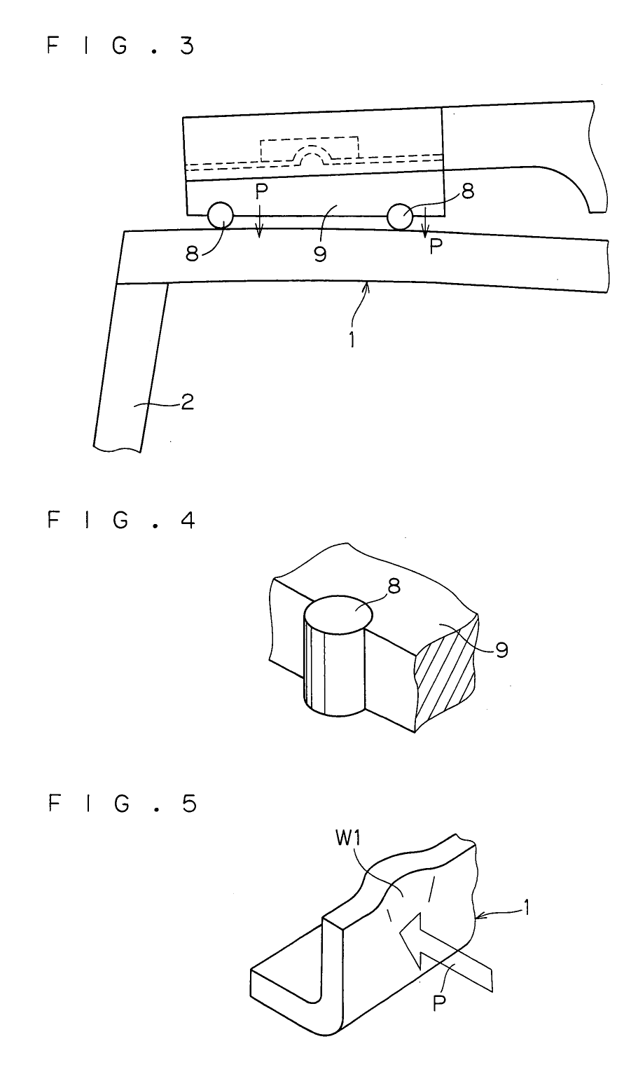

With reference to FIG. 2, in manufacturing such a conventional color selection electrode structure, pressure is applied to both of the H-members 1 in an inward direction P in such a manner that the H-members 1 get closer to each other, whereby each V-member 2 is elastically deformed with two ends inwardly compressed (first step).

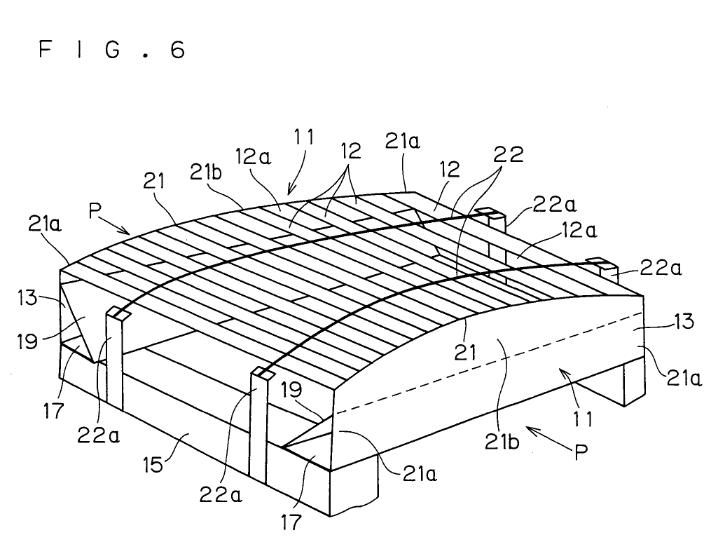

With regard to application of a pressure to the H-members 1, pressure cylinders 8 press the outer surface of each support member 1 through line contact in the inward direction P, as shown in FIGS. 3 and 4. Reference numeral 9 represents a pressure cylinder holder.

While the H-members 1 are under pressure, the grille strips 3 constituting a mask are cooperatively fixed by seam welding between these H-members 1 (second step). This allows a tension to be caused in each of the grille strips 3 by the resilience of the V-members 2 when the pressure applied to the H-members 1 is released (third step).

At this stage, the grille strips 3, the H-members 1, and the V-members 2 are blackened by application of a coating for rust prevention.

Thereafter, the base end of each damper spring 7 for supporting each end of the damper wire 6 is fixed to the V-member 2, to establish contact between the damper wires 6 and each of the grille strips 3 (fourth step).

Preferred Embodiment

In the conventional color selection electrode structure, an exemplary of which is shown in FIG. 1, the H-members 1 are relatively large in thickness and thus heavily weigh. That is, the H-members 1 cannot favorably be used in terms of resistance to application of a pressure and drop impact.

Further, pressure applied by the pressure cylinders 8 to the bottom of each H-member 1 through line contact, as shown in FIG. 3, generally creates an indentation W1 in each H-member 1 shown in FIG. 5.

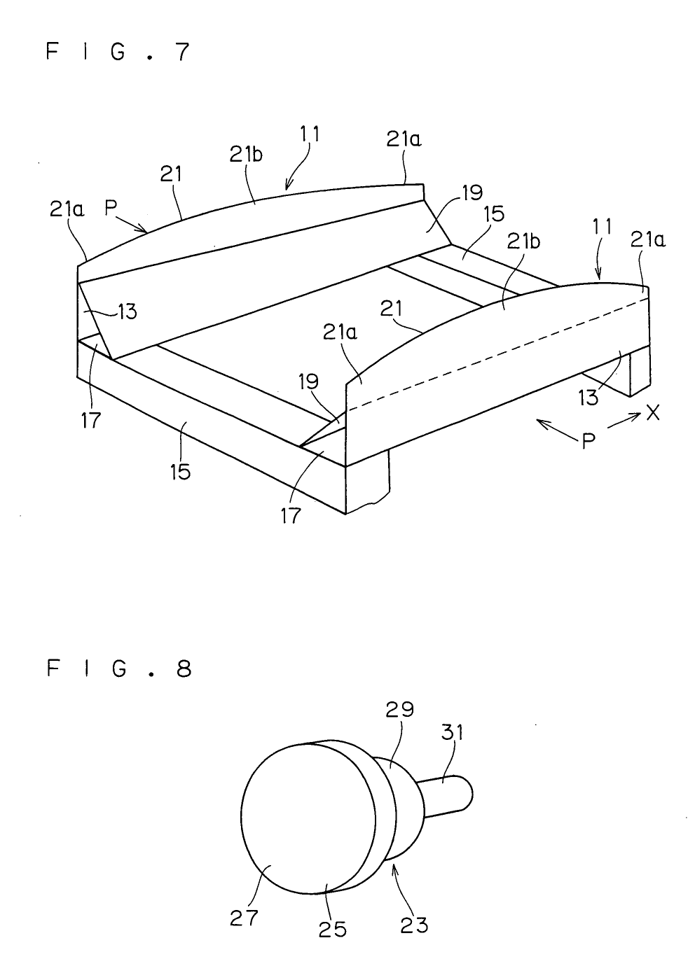

In response to these, the preferred embodiment of the present invention is directed to weight reduction and prevention of occurrence of an indentation in a color selection electrode structure. With reference to FIG. 6, a color selection electrode structure of the preferred embodiment comprises H-members (support members) 11 which are metal thin plates each being bent in such a manner that the cross section thereof has an approximately triangular shape. The H-members 11 correspond to the H-members 1 of the color selection electrode structure shown in FIG. 1. The H-members 11 as a pair are arranged in parallel, facing each other. A plurality of vertically-extending grille strips 12, corresponding to the grille strips 3 of the color selection electrode structure of FIG. 1, are cooperatively fixed by seam welding between the H-members 11 to be parallel with each other. Openings 12a defined between adjacent ones of the grille strips 12 are operative to serve as slits for allowing light to pass through. Similar to the V-members 2 of FIG. 1, V-members (elastic members) 15 are operative to apply a bias using their elasticity to both of the H-members 11 in such a direction that the H-members 11 go farther from each other, while supportively fixing the H-members 11 at two ends.

FIG. 7 is a perspective view illustrating a frame (including the H-members 11 and the V-members 15) of the color selection electrode structure. Grille strips as parts of the frame are omitted from FIG. 7. The H-members 11 of the frame form top and bottom legs of an aperture grille, whereas the V-members 15 form side legs of this aperture grille.

The metal thin plate, which is to be bent to form the H-members 11, includes such a material with a 0.2% yield strength which satisfies an expression (1) to be described later. By way of example, a 0.2% yield strength of such a material should be 80 kgf/mm² or 40 kgf/mm². This metal thin plate has such a thickness satisfying the to-be-described expression (1), and is not similar to the one of the H-member 1 of the conventional color selection electrode structure shown in FIG. 1. As an example, this metal thin plate has a small thickness in the range of about 1.0 to 1.8 mm, and preferably, of about 1.5 mm.

With regard to the section shape of each H-member 11, one side of a triangle is an outer wall 13 forming the outer surface of the H-member 11, another side is a fixed base wall 17 fixed to the V-member 15 by seam welding, and the other side is an inclined inner wall 19 having an inclination from an inner end portion of the fixed base wall 17 toward the outer wall 13.

The H-member 11 is so bent that the surface to be the outer wall 13 and the surface to be the fixed base wall 17 are perpendicular to each other. The inclined inner wall 19 is so arranged that it touches the midpoint of the outer wall 13, which contact is then joined by welding, for example. The edge of the inclined inner wall 19 enhances the strength of the midpoint of the outer wall 13 by the joint therebetween.

The outer wall 13 has such a structure, when viewed in the direction P indicated in FIGS. 6 and 7, that a central portion 21b is greater in height than peripheral portions 21a at two ends, and an edge 21 has an approximately arc shape. The plurality of grille strips 12 are cooperatively fixed by seam welding, with end portions aligned along the edge 21 as shown in FIG. 6.

The color selection electrode structure of the preferred embodiment is provided with a pair of damper wires 22 contacting all the grille strips 12 to prevent vibration thereof. The damper wires 22 are each perpendicular to the grille strips 12. To maintain tension of the damper wires 22, both ends of each damper wire 22 are supported by tips of elastic damper springs 22a provided outside of each damper wire 22. The damper springs 22a each have a base end secured to the outer surface of the V-member 15.

As discussed, the plurality of grille strips 12 are cooperatively fixed along the approximately arc-shaped edge 21 of the outer wall 13 of each H-member 11. As long as no undesirable such as a wrinkle is generated in the H-member 11, the approximately arc shape of the edge 21 of the outer wall 13 is maintained, whereby the damper wires 22 can efficiently be in contact with all the grille strips 22.

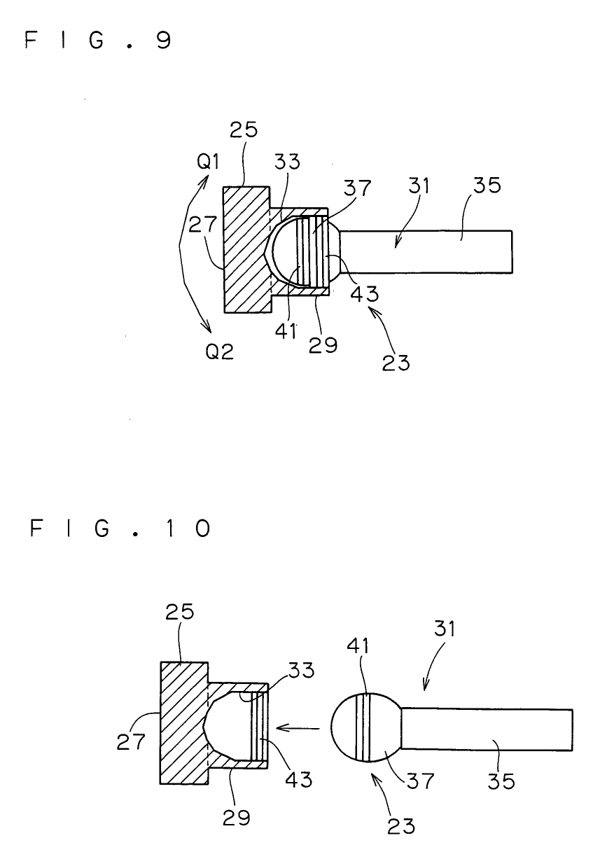

FIGS. 8 and 9 each illustrate a pressure member 23 for pressing the H-members 11 in the inward direction P. The pressure member 23 has a disc-shaped pressure element 25, a supporting portion 29, and a pressure rod 31. The pressure element 25 has surface-to-surface contact with each H-member 11. The supporting portion 29 is provided on the side (back side) opposite to a contact surface 27 of the pressure element 25 which comes into contact with each H-member 11, and is operative to supportively fix the pressure element 25. The pressure rod 31 is loosely fitted in the supporting portion 29. While supporting the supporting portion 29 in a manner allowing rotatable (swingable) movement of the supporting portion 29 in all directions relative to the contact surface 27, the pressure rod 31 presses the supporting portion 29 toward the contact surface 27.

The pressure element 25 includes resin and the like. The contact surface 27 has a circular shape with a radius which satisfies the to-be-described expression (1). By way of example, the contact surface 27 has a radius of about 8 mm.

The pressure element 25 should be constant in radius. This is because reduction in contact area of the contact surface 27 of the pressure element 25 for pressing the outer wall 13 of the H-member 11 leads to greater contact stress as caused by the conventional line contact, thus partially causing deformation of the outer wall 13 of the H-member 11. As a result, a “wrinkle” is likely to occur when the mask is stretched.

The supporting portion 29 includes the same material as the pressure element 25, and is formed on the back surface of the pressure element 25. The supporting portion 29 and the pressure element 25 are molded in one piece. The supporting portion 29 has a columnar outer wall. A hole 33 having an approximately cup-like shape is provided on the back surface of the supporting portion 29 to allow the tip of the pressure rod 31 to be loosely fitted therein.

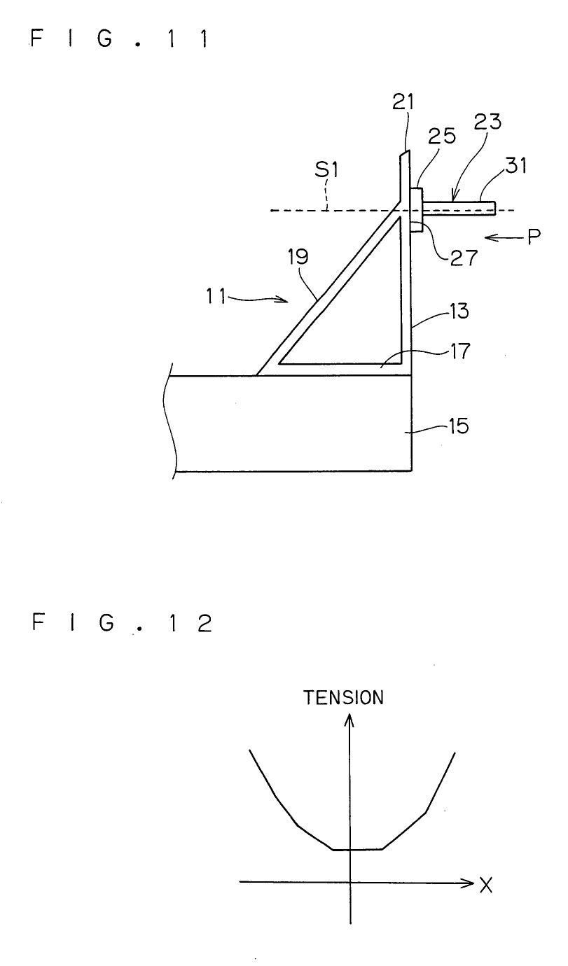

With reference to FIG. 10, the pressure rod 31 is molded separately from the pressure element 25 and the supporting portion 29. A spherical or ellipsoidal portion 37, to be inserted in the hole 33 of the supporting portion 29, is fixed to an end of a columnar body 35. The portion 37 and the columnar body 35 may alternatively be molded in one piece. The portion 37 of the pressure rod 31 is set to be slightly smaller in diameter than the hole 33 of the supporting portion 29, whereby the portion 37 can be in a floating state in the hole 33.

Screw threads 41 with a constant width are formed in the midpoint of the portion 37 of the pressure rod 31. Screw threads 43 corresponding to the screw threads 41 of the portion 37 are formed in the inner periphery of the hole 33 of the supporting portion 29 near its opening. With reference to FIG. 10, in order for the portion 37 to be fitted in the hole 33, the screw threads 41 of the portion 37 are engaged with the screw threads 43 of the hole 33. This engaged stage continues when the pressure rod 31 is thereafter rotated in such a way that the screw threads 41 thereof get closer to the inside than the screw threads 43 of the hole 33. When all the screw threads 41 of the pressure rod 31 pass the screw threads 43 of the hole 33, the engagement between the portion 37 and the hole 33 is released, whereby the portion 37 is loosely fitted in the hole 33.

As a result, the pressure element 25 supported by the supporting portion 29 is allowed to have a clearance which provides rotatable (swingable) movement of the pressure element 25 in all directions relative to the pressure rod 31 including directions Q1 and Q2 indicated in FIG. 9.

The pressure member 23 of the foregoing configuration provides swingable movement of the pressure element 25. When the pressure element 25 applies a pressure to the H-members 11, the contact surface 27 of the pressure element 25 is thus allowed to securely maintain surface-to-surface contact with the outer wall 13 of each H-member 11.

For better sliding movement of the portion 37, lubricating oil such as grease is applied in the hole 33.

The method of manufacturing the color selection electrode structure for a color cathode ray tube according to the preferred embodiment will be described next.

With reference to FIG. 7, a pressure is applied to both of the H-members 11 in the inward direction P in such a manner that the H-members 11 get closer to each other, whereby each V-member 15 is elastically deformed with two ends inwardly compressed (first step).

With regard to application of a pressure to the H-members 11, the pressure member 23 illustrated in FIGS. 8 and 9 presses the outer surface of each H-member 11 through surface-to-surface contact by the contact surface 27 in the inward direction P.

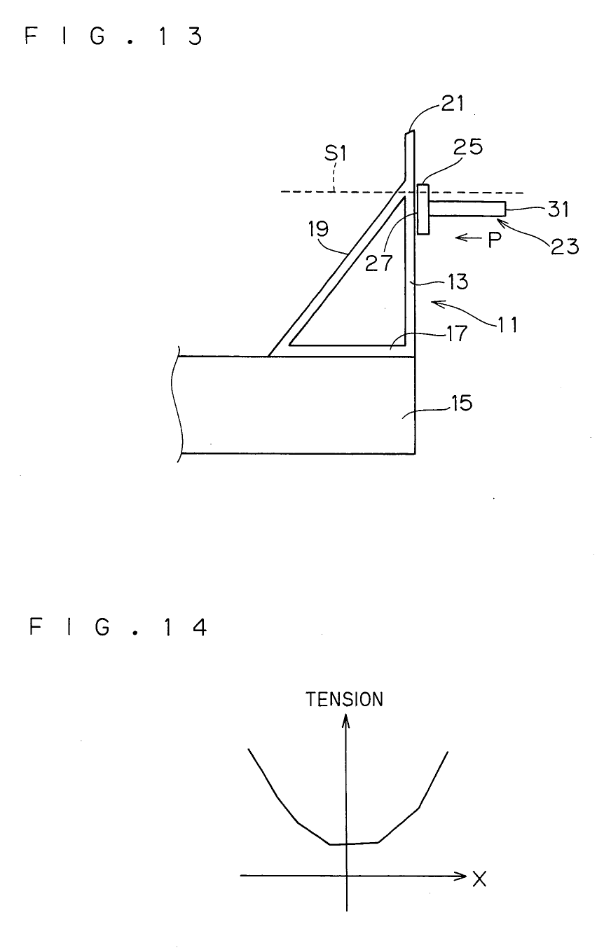

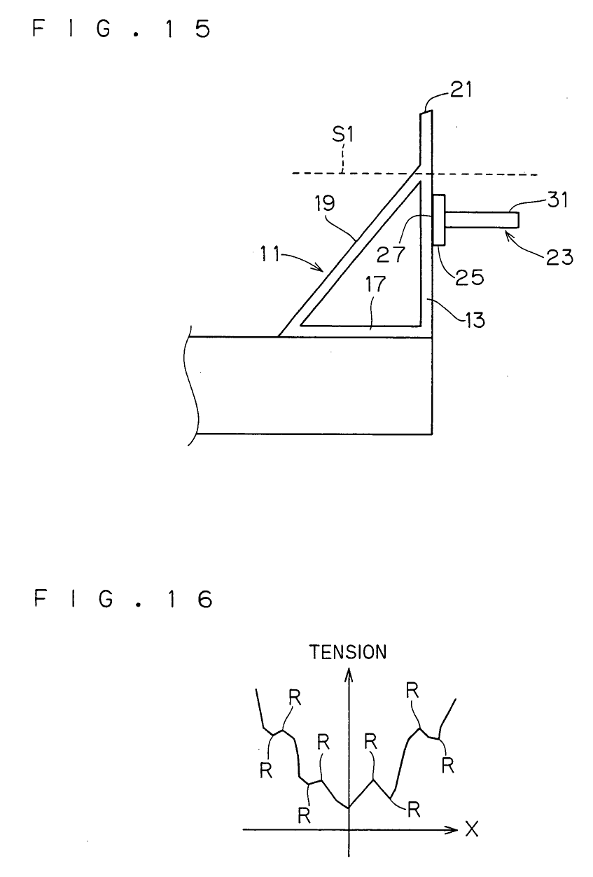

More particularly, a position for applying a pressure by the pressure member 23 is determined in such a way that the contact surface 27 of the pressure element 25 covers a joint S1 between the outer wall 13 and the inclined inner wall 19 of each H-member 11, as shown in FIGS. 11 and 13.

With reference to FIG. 11, when the central portion of the contact surface 27 coincides with the joint S1 between the outer wall 13 and the inclined inner wall 19, a tension distribution in the tension mask after placement of the grille strips 12 in a tensioned state has a smooth U-shaped curve as shown in FIG. 12. In FIG. 12, the horizontal axis shows position coordinates X indicated in FIG. 7.

With reference to FIG. 13, even when the central portion of the contact surface 27 does not coincide with the joint S1 between the outer wall 13 and the inclined inner wall 19, the contact surface 27 covering the joint S1 is allowed to be controlled at a correct angle in response to a stress by means of swingable movement of the pressure element 25 as discussed. With reference to FIG. 14, a tension distribution in the tension mask after placement of the grille strips 12 in a tensioned state thus has a smooth U-shaped curve which is similar to the one shown in FIG. 12. In FIG. 14, the horizontal axis also shows position coordinates X indicated in FIG. 7.

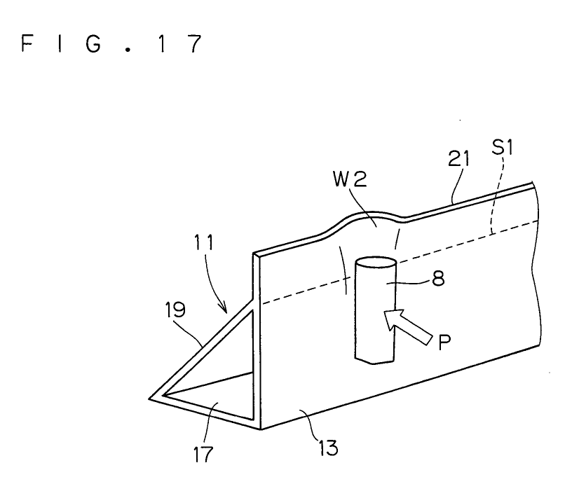

In contrast, the joint S1 may not be covered by the contact surface 27 of the pressure element 25, an example of which is shown in FIG. 15. In this case, even the swingable movement of the pressure element 25 cannot provide a correct angle of the contact surface 27 in response to a stress, causing the pressure element 25 to press the outer wall 13 of each H-member 11 in an improper direction. Due to this, the outer wall 13 of each H-member 11 may be partially deformed, resulting in generation of a wrinkle therein. In this case, experimental results show that a tension distribution in the tension mask after placement of the grille strips 12 in a tensioned state has inflection points P at such wrinkles as shown in FIG. 16. It is visually confirmed that a display oscillation property is degraded at these inflection points P.

In view of these, the outer wall 13 of each H-member 11 should be pressed by the pressure member 23 in such a way that the contact surface 27 of the pressure element 25 covers the joint S1 as shown in FIGS. 11 and 13.

Using positions as parameters at which the contact surface 27 of the pressure element 25 comes into contact with the outer wall 13 of each H-shaped member 11, a tension distribution and display oscillation have been examined by experiment, the results of which are shown in the following Tables 1 through 4.

TABLE 1

| | | | | (Pressure/ | | |
|---|---|---|---|---|---|---|
| | Contact | Pressure | Pressure/ | Contact Area)/ | Presence | 0.2% Yield |
| Radius r | Area | (kgf) | Contact area | \sqrt{Thickness} | of Wrinkle | Strength/10 |
| 10 | 314.159 | 400 | 1.27 | 1.27 | No | 8 kgf/mm² |
| 9 | 254.46879 | 400 | 1.57 | 1.57 | No | 8 kgf/mm² |
| 8 | 201.06176 | 400 | 1.99 | 1.99 | No | 8 kgf/mm² |
| 7 | 153.93791 | 400 | 2.60 | 2.60 | No | 8 kgf/mm² |
| 6 | 113.09724 | 400 | 3.54 | 3.54 | No | 8 kgf/mm² |
| 5 | 78.53975 | 400 | 5.09 | 5.09 | No | 8 kgf/mm² |
| 4 | 50.26544 | 400 | 7.96 | 7.96 | No | 8 kgf/mm² |
| 3 | 28.27431 | 400 | 14.15 | 14.15 | Yes | 8 kgf/mm² |
| 2 | 12.56636 | 400 | 31.83 | 31.83 | Yes | 8 kgf/mm² |
| 1 | 3.14159 | 400 | 127.32 | 127.32 | Yes | 8 kgf/mm² |

TABLE 2

| | | | | (Pressure/ | | |
|---|---|---|---|---|---|---|
| | Contact | Pressure | Pressure/ | Contact Area)/ | Presence | 0.2% Yield |
| Radius r | Area | (kgf) | Contact area | \sqrt{Thickness} | of Wrinkle | Strength/10 |
| 10 | 314.159 | 400 | 1.27 | 1.27 | No | 4 kgf/mm² |
| 9 | 254.46879 | 400 | 1.57 | 1.57 | No | 4 kgf/mm² |
| 8 | 201.06176 | 400 | 1.99 | 1.99 | No | 4 kgf/mm² |
| 7 | 153.93791 | 400 | 2.60 | 2.60 | No | 4 kgf/mm² |
| 6 | 113.09724 | 400 | 3.54 | 3.54 | No | 4 kgf/mm² |
| 5 | 78.53975 | 400 | 5.09 | 5.09 | Yes | 4 kgf/mm² |
| 4 | 50.26544 | 400 | 7.96 | 7.96 | Yes | 4 kgf/mm² |
| 3 | 28.27431 | 400 | 14.15 | 14.15 | Yes | 4 kgf/mm² |
| 2 | 12.56636 | 400 | 31.83 | 31.83 | Yes | 4 kgf/mm² |
| 1 | 3.14159 | 400 | 127.32 | 127.32 | Yes | 4 kgf/mm² |

TABLE 3

| | | | | (Pressure/ | | |
|---|---|---|---|---|---|---|
| | Contact | Pressure | Pressure/ | ContactArea)/ | Presence | 0.2% Yield |
| Radius r | Area | (kgf) | Contact area | \sqrt{Thickness} | of Wrinkle | Strength/10 |
| 10 | 314.159 | 400 | 1.27 | 0.95 | No | 8 kgf/mm² |
| 9 | 254.46879 | 400 | 1.57 | 1.17 | No | 8 kgf/mm² |
| 8 | 201.06176 | 400 | 1.99 | 1.48 | No | 8 kgf/mm² |
| 7 | 153.93791 | 400 | 2.60 | 1.94 | No | 8 kgf/mm² |
| 6 | 113.09724 | 400 | 3.54 | 2.64 | No | 8 kgf/mm² |
| 5 | 78.53975 | 400 | 5.09 | 3.80 | No | 8 kgf/mm² |
| 4 | 50.26544 | 400 | 7.96 | 5.93 | No | 8 kgf/mm² |
| 3 | 28.27431 | 400 | 14.15 | 10.54 | Yes | 8 kgf/mm² |
| 2 | 12.56636 | 400 | 31.83 | 23.73 | Yes | 8 kgf/mm² |
| 1 | 3.14159 | 400 | 127.32 | 94.90 | Yes | 8 kgf/mm² |

TABLE 4

| | | | | (Pressure/ | | |
|---|---|---|---|---|---|---|
| | Contact | Pressure | Pressure/ | Contact Area)/ | Presence | 0.2% Yield |
| Radius r | Area | (kgf) | Contact area | \sqrt{Thickness} | of Wrinkle | Strength/10 |
| 10 | 314.159 | 400 | 1.27 | 0.81 | No | 8 kgf/mm² |
| 9 | 254.46879 | 400 | 1.57 | 0.99 | No | 8 kgf/mm² |
| 8 | 201.06176 | 400 | 1.99 | 1.26 | No | 8 kgf/mm² |
| 7 | 153.93791 | 400 | 2.60 | 1.64 | No | 8 kgf/mm² |
| 6 | 113.09724 | 400 | 3.54 | 2.24 | No | 8 kgf/mm² |
| 5 | 78.53975 | 400 | 5.09 | 3.22 | No | 8 kgf/mm² |
| 4 | 50.26544 | 400 | 7.96 | 5.03 | No | 8 kgf/mm² |
| 3 | 28.27431 | 400 | 14.15 | 8.95 | Yes | 8 kgf/mm² |
| 2 | 12.56636 | 400 | 31.83 | 20.13 | Yes | 8 kgf/mm² |
| 1 | 3.14159 | 400 | 127.32 | 80.53 | Yes | 8 kgf/mm² |

With reference to Tables 1 and 2, a metal thin plate with a thickness of 1.0 mm is used to form the H-members 11 by bending. Such a metal thin plate has a thickness of 1.8 mm in Table 3, whereas it has a thickness of 2.5 mm in Table 4.

A metal thin plate to be H-members 11 has a 0.2% yield strength of 80 kgf/mm² in Tables 1 and 3, whereas it is 40 kgf/mm² in Tables 2 and 4.

In each one of Tables 1 through 4, the presence or absence of a wrinkle in the outer wall 13 of each H-member 11 has been visually examined in ten stages after application of a pressure of 400 kgf by the circular-shaped contact surface 27 of the pressure element 25 which is gradually varied in radius from 1 mm to 10 mm. Each of Tables 1 through 4 lists the values of radius of the contact surface 27, contact area, pressure, pressure divided by contact area, pressure divided by contact area which is further divided by the square root of thickness of the H-member 11, presence or absence of a wrinkle, and 0.2% yield strength divided by 10.

In view of the experimental results shown in Tables 1 through 4, the present inventors have found that, designating a 0.2% yield strength of the outer wall 13 of each H-member 11 as α, thickness of the H-member 11 as β, pressure as γ, and contact area as δ, there is no generation of a wrinkle in the outer wall 13 as long as the following expression (1) is satisfied:

α/10>(γ/δ)/\sqrt{β} (1)

As a result, generation of a wrinkle is prevented on the conditions that the expression (1) is satisfied, and the contact surface 27 of the pressure element 25 covers the joint S1 as shown in FIGS. 11 and 13.

While the H-members 11 are under pressure, the grille strips 12 (FIG. 6) constituting a mask are cooperatively fixed by seam welding between these H-members 11 (second step).

Next, the pressure applied to the H-members 11 is released, whereby the resilience of the V-members 15 applies a bias to the H-members 11 in a direction that the H-members 11 go farther from each other. This allows a tension to be caused in each of the grille strips 12 (third step).

At this stage, the grille strips 12, the H-members 11, and the V-members 15 are blackened by application of a coating for rust prevention.

Thereafter, the base end of each damper spring 22a for supporting each end of the damper wire 22 is fixed to the V-member 15. The damper wires 22 and each one of the grille strips 12 thus come into contact with each other (fourth step), to reach the color selection electrode structure for a color cathode ray tube illustrated in FIG. 6.

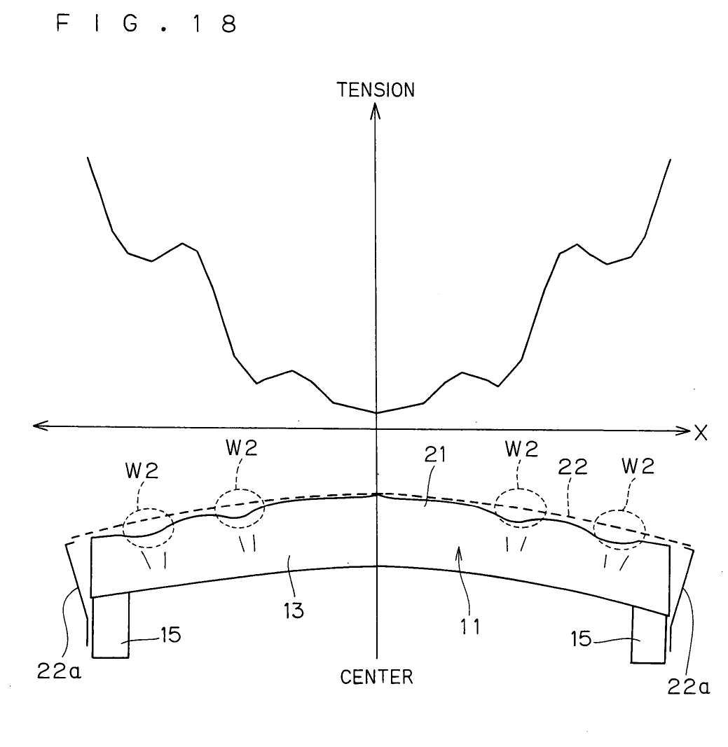

In the foregoing first step, the outer wall 13 of each H-member 11 of the preferred embodiment illustrated in FIGS. 6 and 7 may be pressed through line contact by the exemplary pressure cylinder 8 discussed with reference to FIGS. 3 and 4. Such line contact limits the contact area δ in the expression (1) to an extremely small extent, thereby causing difficulty in obtaining factors that satisfy the expression (1) as an inequality. In view of this, even when the pressure cylinder 8 comes into contact with the outer wall 13 in such a way that the pressure cylinder 8 covers the joint S1 between the outer wall 13 and the inclined inner wall 19 of each H-member 11, a wrinkle W2 is generated as shown in FIG. 17. With reference to FIG. 18, after placement of the grille strips 12 in a tensioned state to form a tension mask, such a case leads to a tension distribution in this tension mask which has inflection points R at the wrinkles W2.

With reference to FIG. 18, the edge 21 defined by the joints between each grille strip 12 and each H-member 11 has recesses at the wrinkles W2, failing to make contact between the grille strips 12 joined to such recesses and the damper wires 22. As a result, the damper wires 22 cannot be operative to hold such grille strips 12, thereby causing a high probability of vibration of these grille strips 12.

In contrast, according to the preferred embodiment of the present invention, the pressure element 25 of the pressure member 23 applies a pressure to the outer wall 13 of each H-member 11 through surface-to-surface contact, and the contact surface 27 of the pressure element 25 is set to cover an area which satisfies the foregoing expression (1). Generation of the wrinkle W2 is thus prevented in the outer wall 13 of each H-member 11, thereby providing a smooth U-shaped curve of a tension distribution in the tension mask after placement of the grille strips 12 in a tensioned state, as shown in FIGS. 12 and 14. The preferred embodiment of the present invention further advantageously avoids a clearance between the damper wires 22 and the grille strips 22 as in FIG. 18, resulting in prevention of display oscillation and enhancement in image quality in the case of visual recognition by a user.

As described, in the preferred embodiment of the present invention, a tension distribution causing no degradation of a display oscillation property can be obtained with the H-members (support members) 11 of an approximately triangular shape in cross section which are controlled to be small in the thickness β especially for weight reduction. Further, application of a pressure by the pressure member 23 causes no partial deformation of the H-members (support members) 11, whereby generation of the wrinkle W2 is prevented.

In the preferred embodiment of the present invention, the contact surface 27 of the pressure element 25 has a circular shape. However, the contact surface 27 is not limited to be circular in shape, as long as the foregoing expression (1) is satisfied, and the contact surface 27 covers the joint S1 as shown in FIGS. 11 and 13. By way of example, the contact surface 27 may alternatively be square, triangular, or the like in shape, which alternative shapes also produce the same effects.

While the invention has been shown and described in detail, the foregoing description is in all aspects illustrative and not restrictive. It is therefore understood that numerous modifications and variations can be devised without departing from the scope of the invention.

What is claimed is:

1. A method of manufacturing a color selection electrode structure for a color cathode ray tube, said color selection electrode structure including a pair of support members opposite to each other, elastic members for supporting said support members, while applying a bias to said support members in such a manner that said support members go farther from each other, and a plurality of grille strips each having two ends supported by said support members, said method comprising the steps of:
a) applying a pressure by a pressure member to said support members to be closer to each other which are each a thin plate approximately triangular in cross section, in such a manner that a contact surface of said pressure member which comes into contact with said support members covers a joint between two sides of each of said support members having an approximately triangular shape in cross section;
b) while maintaining said pressure applied in said step a), cooperatively fixing said plurality of grille strips between said support members;
c) releasing said pressure applied to said support members, to cause a tension in each of said plurality of grille strips supported by said support members using resilience of said elastic members; and
d) placing a damper wire to be in contact with each of said plurality of grille strips.

2. The method according to claim 1 which satisfies the expression
α/10>(γ/δ)/\sqrt{β},
where α is a 0.2% yield strength of an outer wall of a thin plate constituting said support members which is in contact with said pressure member, β is a thickness of said thin plate, γ is a pressure to be applied by said pressure member, and δis an area of said contact surface.

3. The method according to claim 1,
wherein said support members are predetermined metal thin plates each being bent into an approximately triangular shape in cross section, including:
an outer wall forming an outer surface;
a fixed base wall cooperatively fixed to said elastic members; and
an inclined inner wall having an inclination from an inner end portion of said fixed base wall toward said outer wall,
wherein said outer wall has such a structure that a central portion is greater in height than peripheral portions at two ends, whereby an edge of said outer wall has an approximately arc shape, and
wherein said plurality of grille strips are cooperatively fixed along said edge.

4. The method according to claim 1,
wherein said pressure member used in said step a) comprises:
a pressure element which comes into contact with said support members through surface-to-surface contact; and
a pressure rod loosely fitted in said pressure element on the side opposite to said contact surface which is in contact with said support members, said pressure rod pressing said pressure element toward said contact surface while supporting said pressure element in a manner allowing swingable movement of said pressure element in all directions relative to said contact surface.

5. The method according to claim 4,
wherein a hole is formed on a back surface of said pressure element, whereby a tip of said pressure rod is loosely fitted in said hole,
wherein said pressure rod includes a columnar body, and a spherical or ellipsoidal portion to be inserted in said hole, said portion of said pressure rod being fixed to an end of said columnar body, or being molded in one piece with said columnar body, and
wherein said portion of said pressure rod is smaller in diameter than said hole.
